(19) United States
(12) Patent Application Publication
(10) Pub. No.: US 2008/0073432 A1
(43) Pub. Date: Mar. 27, 2008

(54) Method And System For Improving, Modifying, And Adding Information During A Transfer Or Transaction

(76) Inventors: Ronald Barenburg, New York, NY (US); Rhett C. Bordner, Tempe, AZ (US)

Correspondence Address: LACKENBACH SIEGEL, LLP, LACKENBACH SIEGEL BUILDING, 1 CHASE ROAD, SCARSDALE, NY, 10583, US

(21) Appl. No.: 11/813,240

(22) PCT Filed: Jan. 6, 2006
(86) PCT No.: PCT/US06/00628

§ 371 Date: Nov. 6, 2007

Related U.S. Application Data
(60) Provisional application No. 60/641,763, filed on Jan. 6, 2005.

(51) Int. Cl. G06F 19/00

(52) U.S. Cl. 235/385

(57) ABSTRACT

The present invention relates to a method and system for connecting a composite bar code system (connecting a 2-dimensional bar code linked with variable data, to preexisting static data linked with a recognized linear bar code and system) or recognized RFID tag and system with an additional informational need. The present invention further relates to methods and systems for manipulating this connection to tailor a transaction according to a user's adaptive disclosure needs throughout a supply, transfer, or transportation chain.

### CROSS REFERENCE TO RELATED APPLICATIONS

This application is a continuation-in-part of PCT/US04/12418 filed Apr. 22, 2004, and is a continuation-in-part of U.S. Ser. No. 10/829,736 filed Apr. 22, 2004 each of which claim priority to U.S. Provisional Ser. No. 60/505,127 filed 23 Sep. 2003 (currently abandoned) and U.S. Provisional Ser. No. 60/530,415 filed 17 Dec. 2003 (currently abandoned); and this application claims priority from U.S. Provisional Ser. No. 60/641,763 filed 06 Jan. 2005, the contents of each of which are fully incorporated herein by reference.

### SELECTED FIGURE

FIG. 1 is selected for publication.

### BACKGROUND OF THE INVENTION

1. Field of the Invention

The present invention relates to a method and system for connecting a 2-dimensional bar code (including composite bar codes) linked with variable data, to preexisting static data linked with a recognized linear bar code and system or recognized RFID tag and system during a transfer. The present invention further relates to methods and systems for manipulating this connection to tailor a transaction and the information according to a user's needs.

2. Description of the Related Art

In providing a comprehensive description of the present invention and related art, this application necessarily incorporates fully by reference the complete disclosures of U.S. patent application Ser. No. 10/829,736 filed Apr. 22, 2004, currently pending; PCT/US2004/012418 filed Apr. 22, 2004, currently pending, U.S. Prov. App. Ser. No. 60/505,127 filed Sep. 23, 2003, currently abandoned; and U.S. Prov. App. Ser. No. 60/530,415 filed Dec. 17, 2003, currently abandoned.

As discussed in U.S. Pat. No. 6,631,843, optically encoded indicia, such as bar codes are well known in the art but limitations exist. Bar codes carry information encoded into bars and spaces of various widths, arranged in predetermined patterns. The bars and spaces are made up of unit elements called modules within a selected symbology.

At the last count, there were over one hundred (100) defined and known bar code symbologies. Unfortunately, only a handful of these symbologies are in current use, and fewer still are widely known and used internationally.

A number of different one-dimensional bar code symbologies (alternatively called or referred to as 1D-encodation schemes or 1D symbologies) exist. These symbologies include, but are not necessarily limited to: UPC-A, UPC-E, EAN-8, EAN-13 and UCC/EAN-128 and/or other common-type and known 1D bar codes as defined by the representative governing councils, and standards defining organizations. This may also include applicable Application Identifiers, UCC Coupon Value Codes and HIBC UCC/EAN-128 Secondary Input Data formats encoded in UCC/EAN-128, among others known in the 1D bar code symbology field.

It should be noted that the Uniform Code Council, Inc. (UCC) and EAN International are voluntary standards organizations that together manage the EAN/UCC system. The Automatic Identification Manufacturers Association (AIM) and AIDC are also standards defining organizations that set global standards for multiple facets of technology. Unfortunately, traditional 1D bar codes, due to their low information density storage capacity, can carry only a limited amount of information, on the order of ten to twenty letters or digits assigned under relative standards to general-level type information. This general-level type information is usually an index to a particular file or a general database where general-level information (country code, manufacture's name, type of product, UCC identification, etc.) is stored regarding a manufacturer or type of product.

Unfortunately, bar codes as “dumb” vehicles for information have the limitation of being held to a space requirement that puts a ceiling on the amount of information that can be contained in the bar code.

With the advent of two-dimensional (2-D) encodation schemes (alternatively called 2D symbologies or 2D encodation schemes) for bar codes such as: DataMatrix, PDF-417, Reduced Space Symbology (RSS) and Composite Symbology (CS), the amount of information that may be placed into the physical bar code (within a smaller footprint) increased.

Unfortunately 2-D bar code use (and 2D symbology use) in the retail sector is limited by the requirements dictated by the Uniform Code Council (UCC) standard symbology for retail, UPC-A bar codes. The UPC-A standard had a 12 digit, numeric only identifier that breaks down the classification of a product to for items, namely: (1) country code, (2) manufacturer identifier, (3) manufacturer's product identifier and (4) a check digit. Thus, when scanned, a UPC-A bar code points to a line item in a database corresponding to that general product and the line item includes only these four (4) items of product information.

As will be generally described, two-dimensional (2-D) bar codes carry more information per substrate area than linear one-dimensional (1-D) bar codes. 2-D symbols or codes are called two-dimensional because the data in the code is contained in both the horizontal direction (like 1-D/linear codes) and additionally in the vertical direction.

A number of different two-dimensional 2D symbologies exist. Some of the symbologies are: Aztec Code, Code 16K, Code 49, Data Matrix and Maxi-Code, etc.

PDF-417 symbology is one type of ‘stacked’ two-dimensional bar code symbology used when needed to encode a greater amount of information within a limited amount of space, thus giving generating an even higher information density encodation scheme. An example of this type of symbology is discussed in U.S. Pat. No. 5,304,786.

One type of 2D symbology, “Matrix Type codes” (Maxi-Code, Data Matrix etc.) codes provide this type of high information density storage capacity in a reasonable size, but are also susceptible to inter-row cross-talk problems during use. As an additional problem, Matrix codes are not decodable by a laser scanner (must therefore be read by a more sophisticated and costly optical scanner) and therefore may not be used in many laser-scanning applications. In sum, the use of 2D symbology is growing very slowly due to large infrastructure costs, the cross-talk problem noted above, and other concerns commonly known.

There remains, however, an increasing need for machine-readable symbols that contain more information than conventional bar code symbols. These types of symbols are generally referred to as Reduced Space Symbology (RSS) and Composite Symbology (CS) symbols and should be understood as also being either types of 1D or 2D symbologies depending upon their actual design (as will be discussed below), and may be included in references hereafter to 1D or 2D symbologies as will be noted.

In detail, the first of these new symbologies, Reduced Space Symbologies (RSS), consists of a “high density” 1-D or Linear bar code, designed to encode standard UCC/EAN Item Numbers-up to 14 digits in a reduced-size footprint, resulting in a higher “data capacity” than existing UCC/EAN bar codes. Several variants of RSS exist, including Limited RSS, Stacked RSS and Expanded RSS. Expanded RSS includes the ability to encode limited amounts of additional data beyond the basic UCC/EAN Item Number.

There are four different versions of the RSS family, each with slightly different features. Each version is designed to contain the UCC/EAN's designated Global Trading Identification Number (GTIN).

RSS-14 encodes the full 14 digit UCC/EAN Item Number in a linear symbol that can be scanned rasteringly or omni-directionally by suitably programmed scanners. See Symbol 1.

[image]

RSS-14 LIMITED is a 1D linear symbol that encodes a 14 digit UCC/EAN Item Number with a Packaging Indicator/Logistical Variant of zero or one as a prefix to the following number. It is designed for use on small items where label space is horizontally restricted, and will not be scanned at point of sale (POS). See Symbol 2.

[image]

RSS-14 STACKED is a variation of the RSS-14 symbology that is vertically truncated and stacked in two rows, and is used where label space is vertically restricted, and particularly on items that are not intended to be scanned at point of sale. See Symbol 3.

[image]

RSS EXPANDED encodes a UCC/EAN Item Number plus supplementary element strings such as weight and “best use before” date in a linear symbol that can be scanned omni-directionally by suitably programmed point-of-sale (POS) scanners. RSS Expanded can also be printed in multiple rows as a stacked symbol when the normal symbol would be too wide for the narrow applications. RSS Expanded has a maximum data capacity of 41 alphanumeric or 74 numeric characters. See Symbol 4.

[image]

Any member of the RSS family can be printed as a stand-alone linear symbol or as the Linear ( 1-D) Component of a Composite (2-D) Symbol.

The second new symbology, Composite Symbology (CS), consists of a 1-D symbol (RSS, UPC/EAN or UCC/EAN-128) paired with, and optionally in some cases ‘electronically’ and logically ‘linked’ to a 1-D symbol printed ‘in the immediate area’ of the 1D symbol. The 2-D symbol is either a PDF-417 symbol, or a UCC/EAN specific variant of Micro-PDF-417. Micro-PDF-417 is the version of PDF-417 designed for small item marking applications (small size), for example in semiconductor and electronic component manufacture. Collectively reference to a Composite Symbology hereafter may refer to a linked or non-linked/unlinked Composite Symbology depending upon the reference as noted herein.

In a conventional Composite Symbol (CS), the 1-D bar code is always immediately present and contains primary product identification information. Several types of Composite Symbols (CS) have been organizationally defined. The data capacity of the Composite (2-D) Component ranges from 56 digits to a maximum of 2361 digits.

As noted, present Composite Symbology (CS) technology combines a 1-D bar code with a high-capacity 2-D symbol based on PDF-417 or Micro-PDF in a single code printed together. In CS, the 2-D symbol is referred to as the Composite Component (CC) whilst the 1-D symbol is known as the Linear Component (LC).

There are three variants of the Composite Component (CC) each with a different data capacity: (A) CC-A has a data capacity of up to 56 digits and uses a UCC/EAN defined variant of Micro-PDF. (B) CC-B has a data capacity of up to 338 digits and uses standard Micro-PDF with a UCC/EAN reserved codeword. (C) CC-C has a data capacity of up to 2361 digits and uses a standard PDF-417 with a UCC/EAN reserved codeword.

A key concept within the Composite Symbology (CS) is ‘linking.’ The Composite Component (CC) of a Composite Symbol (CS) is printed in immediate conjunction with or in immediate reference with a 2-D bar code symbol, (the Linear Component (LC)).

In ‘linking,’ the 2-D (LC) symbol always contains the primary product identification. The conventional Composite Component (CC), always contains a special codeword indicating that the data is in accordance with UCC/EAN standards; e.g., (a) that a 2-D symbol is also present (required to read), and (b) that the 2-D bar code is “linked” to the 2-D symbol.

In conventional CS, “where possible” (e.g., optionally), the 2-D bar code also contains a “link,” indicating that a Composite Component (CC) is present and that the 1-D bar code is linked thereto. Here, “where possible” reflects the fact that while some 1-D/LC symbologies, such as RSS, call support such a link, other 1-D/LC symbologies such as UPC/EAN and UCC/EAN-128, cannot. Depending on the application, the 1D bar code used within the Composite Symbol (CS) can be RSS, UPC/EAN or UCC/EAN-128.

Unfortunately, some restrictions exist using the CS format. For example, RSS can be used only with CC-A and CC-B symbologies. As further explanation, the following examples and symbols are included.

Example 1, Composite Symbology (CS) with RSS-14 limited symbology. See Symbol 5.

[image]

Example 2, Composite Symbol (CS) with RSS-14 stacked symbology. See Symbol 6.

[image]

Example 3, Composite Symbol (CS) with UCC/EAN-128 type symbology. See Symbol 7.

[image]

Example 4, Composite Symbol (CS) with UPC-A type symbology. See Symbol 8.

[image]

Additionally, Composite Symbology (CS) concepts are also applicable to other symbologies, including RSS, RSS-14 Truncated, RSS-14 Expanded, RSS-14 Stacked Omni-directional, UPC-E, EAN-13, EAN-8, with the corresponding Composite variants: CC-A/B, CC-A/B (14), CC-C and CC-C (14).

In sum, conventional Composite Symbology (CS), which incorporates a 1-D linear component with a 2-D Composite Component, is a new class of symbology designed to address applications that are not being met by current technology solution sets. Composite Symbology (CS) should be understood as a combination of two encodation schemes, generally a 1D and 2D scheme.

Unfortunately, where new 1-D, 2-D, or CS technology is created, infringers, copyists, counterfeiters, and other criminals rapidly attempt to duplicate or copy a particular bar code.

For example, a bar code for a particular type of medicine is generated by a manufacturer (ex. Aspirin). The bar code links to a data base and includes information regarding generally a manufacture, type of product, description of the product and other “higher-order information” (not specific-item information, as will be described). This same bar code is used on one-hundred (100) bottles of Aspirin placed in a single box with five-hundred (500) other bottles and placed on a pallet with five-hundred (500) other boxes and sent to a shipping agent. The shipping agent looses the one box and reports the loss to the manufacturer.

In this example, the box of Aspirin was stolen by one who copies a previously legitimate bar code from the separate legitimate box, re-labels the stolen goods, and ships the now re-labeled goods to a pharmacy. Here, because the linked data base system can only track a product by “higher-order information” and cannot track a product by a designated specific-item information e.g., individual item/bottle/dose/pill (and because the counterfeit bar code is therefore legitimate), the pharmacy when scanning the counterfeit/stolen goods cannot detect the error, the manufacture cannot detect the error, and the pharmacy sells the stolen/counterfeit goods to the public.

Various anti-counterfeiting steps and other measures have been taken. Unfortunately, each step requires an additional change in the manufacturing or review process or has various negative drawbacks related to cost.

Electronic Product Codes (EPC™) have been recently created. EPC™ is a new type of designated alpha-numeric code that operates like the old bar code symbologies, in that when used as a coded general identifier and scanned, links to a line in a database, in many cases an internet-maintained database. The EPC™ identifier consists of a string of characters containing information about a specific product or higher order information, i.e.: manufacturer, object classification, and other identifiers specific to an industry and in some rare cases, and a unique serial number for each designated item.

The EPC™ system is linked solely with, and transmitted by, the RFID tag technology system, either in 64 or 96 bit configurations. As a consequence, the EPC™ system unfortunately necessitates all of the software, hardware, and RFID configurations included in an integrated superstructure, as well as being dependent on the unproven online database for tracking and reporting.

As noted, one other anti-counterfeiting proposal includes the use of RFID technology.

Radio Frequency Identification (RFID) has been touted as the successor to the bar code because of its ability to store much information in a small button or wired label, and have that information read by out-of-line-of-sight readers, in either singularly or in multiple configurations employing RF signal receivers. Read/Write RFID tags may also allow the ‘tagged’ information to be electronically updated. Several drawbacks to the RFID system include the expensive, and the interconnected and integrated infrastructure necessary to support the utilization of RFID as a vehicle for the transportation of information.

Additionally, since RFID technology employs tiny RF (Radio Frequency) signals collected by receivers, the location, type, and positioning of the receivers is critical. Many shippers, transporters, manufacturers, and retailers employ unshielded electrical and data lines throughout their facilities. Consequently, before efficient and secure RFID use is achieved, substantial infrastructure costs and reinvestment may be necessary.

Additionally, while the future utility of RFID tracking is well known, individual privacy concerns have also grown in parallel with the growth of information tracking. Consumer advocates have noted that government agents or criminals employing existing technology RFID scanners may in the future approach a home or office and identify, via RFID signals, the contents, and in other ways conduct a warrant-less search. These concerns have caused privacy advocates to raise objections with the RFID technology.

In sum, there are substantial concerns regarding the standards, technology, and privacy for RFID implementation, and it is clear that many years will pass before use of RFID wide spread. Therefore the present needs incorporate capacities related to RFID but lacking in printed encodation technologies.

What is needed is the capacity for updating of tracking information including the use of variable data in combination with preexisting static data employing item specific composite-type symbologies for easy tracking of individual goods or item information without changing the present physical infrastructure substantially, using known existing printing techniques, and easing the privacy concerns raised by the EPC™/RFID process, while enabling secure information systems to track up-datable user-identified items through changes throughout a transportation system or other transfer while retaining original information.

### OBJECTS AND SUMMARY OF THE SELECTED ASPECTS OF THE INVENTION

One object of the present invention is to provide a method or system for updating identifiers along a supply stream or within an inventory with variable data.

Another object of the present invention is to provide a method or system to include variable data with preexisting static data employing secure composite type technologies that may or may not be individually serialized.

The present invention relates to a method and system for connecting a composite bar code system (connecting a 2-dimensional bar code linked with variable data, to preexisting static data linked with a recognized linear bar code and system) or recognized RFID tag and system with an additional informational need. The present invention further relates to methods and systems for manipulating this connection to tailor a transaction according to a user's adaptive disclosure needs throughout a supply, transfer, or transportation chain.

According to one embodiment of the present invention, there is provided a method comprising the steps of:

The above, and other alternative objects, features, and advantages of the present invention will become apparent from the following description read in conduction with the accompanying drawings, in which like reference numerals designate the same elements.

### BRIEF DESCRIPTION OF THE DRAWINGS

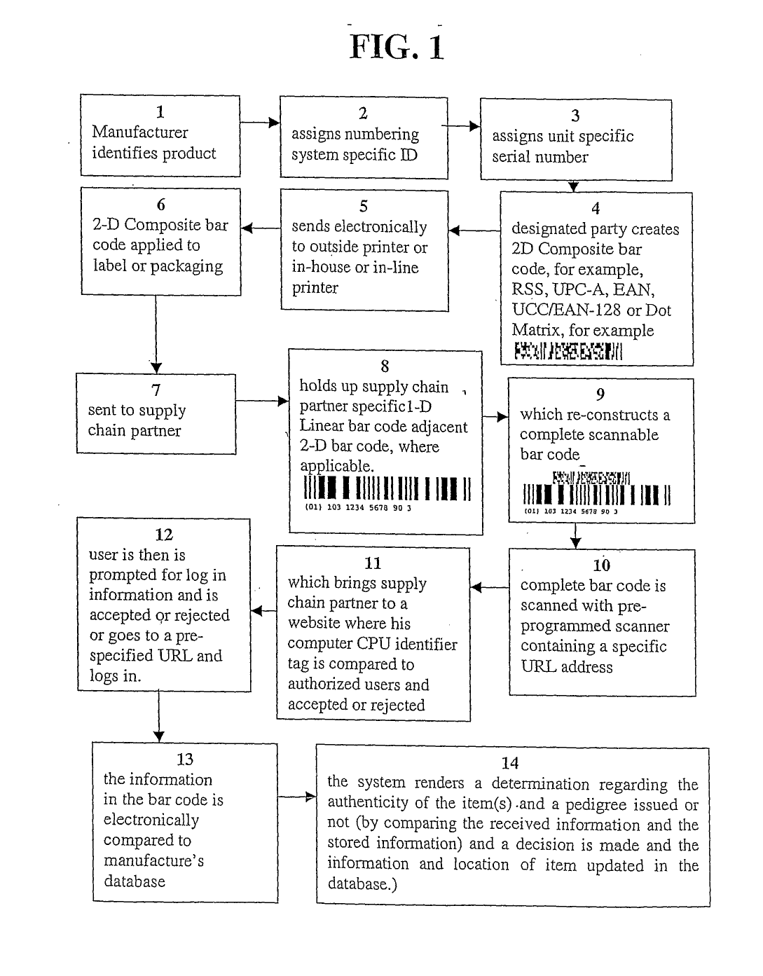

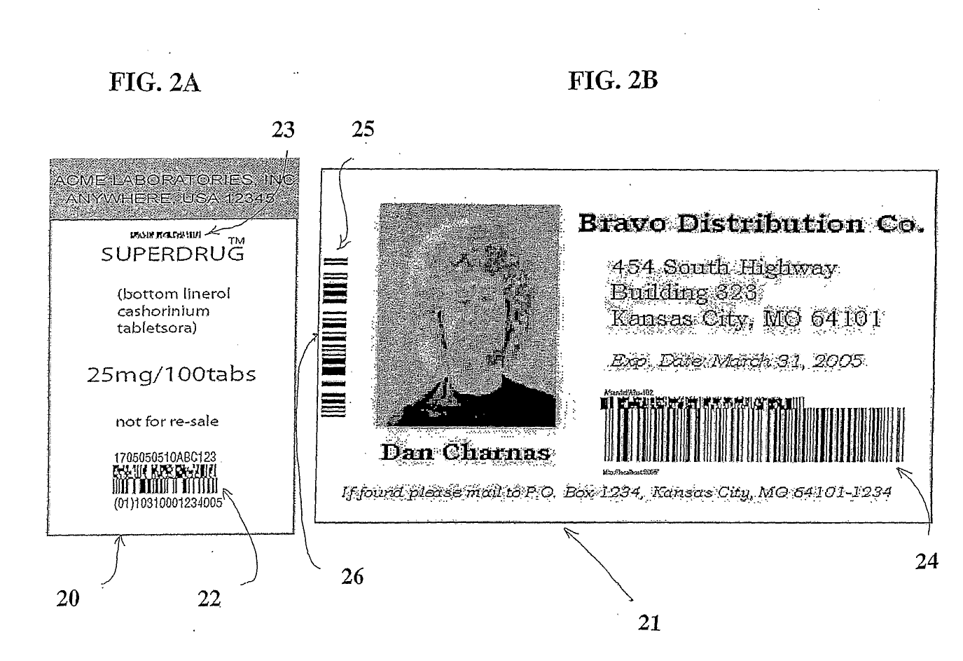

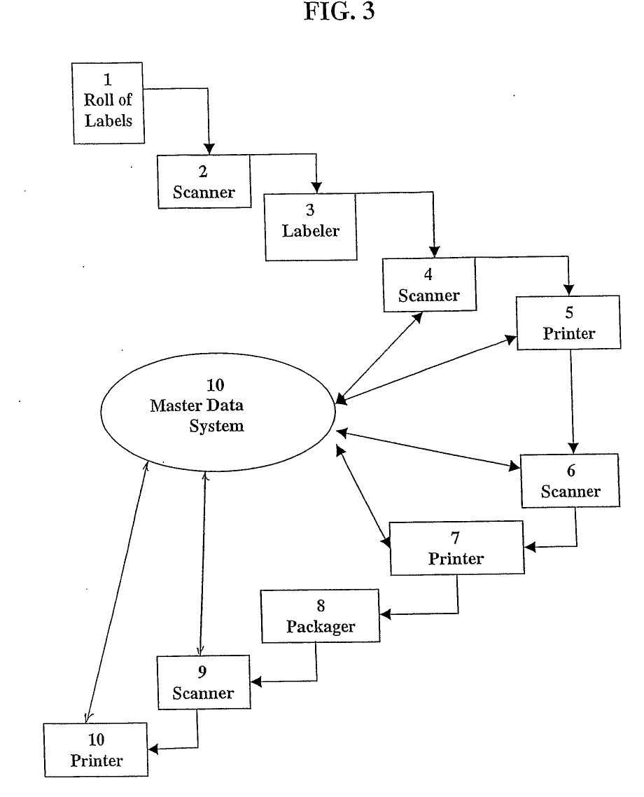

FIG. 1 is a flow diagram describing selected steps of one alternative embodiment of the present invention.

FIG. 2A is a representative example of a label according to one alternative embodiment of the present invention.

FIG. 2B is one representative example of a secure identification tag according to the alternative embodiment shown in FIG. 2A.

FIG. 3 is a descriptive diagram depicting steps in a labeling process according to one alternative embodiment of the present invention.

### DETAILED DESCRIPTION OF PREFERRED EMBODIMENTS

Bar code technologies collectively encompasses the symbologies that encode data to be optically read, the printing technologies that produce machine-readable symbols, the scanners and decoders that capture visual images of the symbologies and covert them to computer-compatible digital data, and the verifiers that validate symbol quality.

As noted earlier, there are many different bar code symbologies, or languages to use an analogy (collectively phrases), and these phrases are at present used in a manner comfortable to those skilled in the art. Each symbology has its own rules for characters (e.g. letter, number, punctuation) encodation, printing and decoding requirements, error checking, and other features.

The various bar code symbologies differ both in the way they represent data and in the type of data they can encode: some symbologies only encode numbers; other symbologies encode numbers, letters, and a few punctuation characters; still other symbologies offer encodation the 128 character set, and even 256 character sets, ASCII sets, etc.

Many construction and practical concerns remain for the wide spread use of RFID technology, and what is needed is a technology that bridges the gaps between presently known bar-code technologies (with their limitations) and the future RFID systems at the present time, and enables sufficient detail in tracking (e.g. item/lot level/container/pill/box) to meet, at lest in part, one of the goals of future RFID systems, namely individual unit pharmaceutical tracking or other specific item tracking (i.e. identifiable to a designated item for example a pill, syringe, bottle, container, pallet, box, machine, etc.). It is particularly noted that item-specific or specific-item information is critical in the high technology or pharmaceutical fields for tracking and safety but due to the very large manufacturing lot sizes, number of manufacturing plants, size of world-wide companies and for other reasons it is presently impractical to create a specific individual item serial number identifying a particular item because the identifying information will be to large to incorporate into present symbology systems. At present only higher order information (even higher-order information of great detail) cannot be used to track individual items in such large numbers as needed in various industries (e.g., individual LED or individual pill tracking) due at least in part to the large number of items involved.

Thankfully, there already exists an alternative to the negatives necessitated by the designated EPC™/RFID process (e.g., expense, altered manufacturing steps, integration difficulties etc.).

As noted earlier conventional Composite Symbology (CS), which generally incorporates a 1-D linear symbology encodation component with a 2-D Composite symbology encodation component, is a new class of symbology. In addition to the conventional broad scope of Composite Symbology (CS) encodation, the present invention additionally envisions Composite Symbology (CS) as optionally incorporating a 2D and a 2D symbology encodation scheme to provide to address applications that are not being met by current technology solution sets and provide additional encodation scope. As a consequence, relative to the present invention and despite other descriptions here, Composite Symbology (CS) should be broadly understood as a combination of two or more encodation schemes, generally a 1D and 2D scheme but now also a 2D scheme and a second or additional 2D scheme or a plurality of 1D/2D schemes.

It is also proposed that using alternative aspects of the present invention, a novel methodology exists to add Composite Symbology (CS) to existing UCC/EAN Linear symbologies, such as, but not limited to: UPC-A, UPC-E, EAN-8, EAN-13 and UCC/EAN-128; in various alternative embodiments to orchestrate this adaptation either after the UCC/EAN symbologies have been created, printed, placed on labels or other substrate; and in yet other alternative embodiments to ‘link’ information by means of adding information in a 2D or Composite format between the Linear and the Composite symbologies, in either a numeric or alpha-numeric or scrambled alpha-numeric format for UPC-A, UPC-E, EAN-8 and EAN-13, and UCC/EAN-128 in order to enhance, change, update, delete or link encoded data contained in the Linear.

In one alternative aspect of one embodiment of the present invention, an item to be tracked is labeled or identified as discussed below with a determined item specific designation, including for example higher order information such as associated manufacture, time, date, place, description, and NDC, and specific item information such as a serial number, and other item selective identifier effective to sufficiently identify a individual item in a discrete manner, e.g. a single ampoule of injectable medicine, or a single box containing a plurality of ampoules.

For example, alternative embodiments of the present invention may be adapted for use in various manners to improve the ability to track or identify consumer products (e.g., pharmaceuticals, livestock, books, food items, clothing items, aircraft parts, automotive parts or other manufactured parts, cargo containers, luggage, personal identification documents (drivers licenses, passports, visa's, etc.), military construction items and parts); and as a result of this tracking or identifying achieve, at least in part, one of the concerns raised in the discussion above.

In other words alternative aspects of the present invention may be adapted for use in reducing counterfeiting, tracking events (such as sporting or entertainment events), minimizing human health concerns over patient consent or privacy or drug receipt, verifying product returns and recalls, tracking vaccines and other biological materials in a private manner, or tracking personnel (e.g. military, prisoner identification), etc.

According to one alternative embodiment of the present invention, incorporating portions of this information, a first code is created (usually a linear or 1D bar code but alternatively a separate 2D or Composite (CS) code may be used as the first code.

This first code (A) (usually a linear code) is created by known technology bar code printing systems (usually by off-site printers or by in-line systems at a manufacturer's or user's production line) and would incorporate higher-level or higher-order information such as country code, manufacturer, product description, place of manufacture, etc.

A second code (B) is then created. This second code (B) includes specific defined item-level information, specific-item information, or individual-use information such as lot, serial number, pallet, date of manufacture, expiration date, URL access data etc, that is known about a determined item. This second code (B) is generated as a Composite Symbology (CS) code and includes a first part (B1) and a second part (B2), where one or both parts is a 2D composite component, and where only one part is a 2D composite component the remaining part is a 1D linear component, depending upon multiple alternative embodiments.

In other words, in one alternative embodiment the second code (here B′), includes a first part (B1) is a linear component and a second part (B2) is a 2D component. In another alternative embodiment the second code (B″) includes a first part (B1) as a first 2D component and a second part (B2) as a second 2D component.

The present invention intentionally provides a portion of the data for the second code (B) in the first part (B1) and continues that information into the second part (B2), creating a Composite Symbology code (B=B1+B2) and rendering the second code (B) unreadable without simultaneously reading (scanning with a laser scanner) both the first (B1) and second (B2) parts together, as part of a Composite Symbology code. This type of separation renders the second code (B) unreadable (un-scannable and unrecognizable) and without utility without both (B1) and (B2) or other portions as will be described.

Alternative embodiments of the present invention may optionally provide additional electronic “hooks” or “tails” in either one of the first (B1) or second parts (B2) of the second code (B) indicating to a properly programmed electronic reader that the other part of the second code (B) is a required element to the second code (rendering the Composite Symbology (CS) Code unreadable when separated) and preventing the reading of the second code (B) where either part (B1, B2) is lacking.

Alternative embodiments to this embodiment may optionally further divide the second code (B) into a third (B3) or even a forth part (B4), rendering the second code (B) unreadable without physically combining all the parts (B1, B2, B3, or B4).

In another alternative embodiment the first code (A) may be similarly physically split into a first part (A1) and a second part (A2) and operate in a similar ‘unreadable’ manner for an additional layer of counterfeit protection. In this alternative embodiment, the item-label would be printed with two partial codes, for example A1 and B2, (requiring A2 and B1 for comprehensive scanning) thereby preventing scanning at even the higher-level order of information.

As an additional alternative embodiment, in either code (first code (A) or second code (B) human readable information may be printed immediately adjacent the code allowing for human-reading of the human-readable information and entering the information in a secure data base to reconstruct a damaged and un-scannable CS code based on the stored specific-item information.

As a consequence of the present design, a manufacturer, employing the present system, method, product, or apparatus would first initially generate a list of desired tracking information including higher-level and item-level, specific-item, or individual-use information and store that information in a secure “trackable” and useable database system specific to the individual or use. An alternative embodiment to the database system would provide an internet-linked or internet-based system allowing access from multiple geographically dispersed locations (or authorized supply chain partners) each accessible via a secured communication link.

In a first example of one alternative embodiment, for a single use item, e.g. single ampoule of medicine, the manufacture would electronically designate a first code (A) using CS or other technology code containing only higher-level information, and a second code (B) containing either both higher-level and item-level information or only item-level information, wherein the second code (B) is divided into at least a first part (B1) and a second part (B2). It should be understood, that the selection of which type of information (serial number, pallet number, part number etc.) to encode using the present embodiment of the invention is a decision for the individual user.

In an alternative embodiment, where an industry is common to individual users (e.g., the drug industry), the users may collectively designate a third party to uniformly designate an information strategy for specific-item information (i.e. following a specific item-information encodation format for all drugs) and hence bring convenient unity to the industry and benefit all individuals. This third party would then provide designated information units in a common data base or set of data bases to each user for incorporation with their secure scanning methods and application to designated specific items.

In this example, the manufacture would then cause a physical item label to be printed for an item including the first code (A) and only one part or portion (B1 or B2) of the second code (B).

The manufacturer would then provide the non-selected part (B1 or B2) of the second code (B) in a secure manner to an authorized end user (Doctor, pharmacy, Hospital user etc.) trained in its use. This type of secure manner may include placing the non-selected part (of second code (B)) on a user specific 1D card identifiable to a person, on a scannable card, or in other physical and electronic ways (programmed into a scanner or scanning control system, etc) common to conventional bar code uses. Thus a two-path delivery practice is provided for at least the physically split second code (B). One path being the label itself, and the second path being the secure transfer to the authorized end user.

As a consequence, the specific item label may be read by scanning the first code (A) into a data base and noting higher-level information (NDC, Manufacturer, etc.) but the label cannot be read by scanning the second code (B) without both parts. Thus, a counterfeiter, forger, or unauthorized user merely copying duplicating an existing label (e. g., stolen or lost label) cannot complete an electronic entry scan (and detect the code elements themselves) because the second code (B) cannot be read without both parts (B1, B2).

An authorized user would scan the first code (A) on the label into the data base and then by completing code (B) (by either physically holding the unused part of the second code (B1) next to printed part (B2) and physically completing the second code (B) or by electronically combining (B1) and (B2) via computer programming solutions) thereby allowing for a completed and successful specific-item or item-level scan of the second code (B) and hence the entire label.

The present invention may be adapted and modified in alternative embodiments according to the situational security needs of the manufacture and customer. Several of the optional alternative embodiments are discussed below.

In an example 5 of one alternative embodiment of the present invention, a 1-D UPC-A Linear code is created with numeric values as shown: See Symbol 9.

[image]

which when scanned would scan as: 312345678906

As more information becomes available, a 2-D Composite is created: See Symbol 10.

[image]

and because this 2-D composite is not a stand alone readable composite code it cannot be scanned alone, but does include selected critical encoded information, e.g. item-level information such as expiration date, lot number, part or item serial number ((17)040404(10)abc123) etc.

In this example, unreadable Symbol 10 may optionally be placed on a drug bottle, a syringe body, or on a single specific-item label, and Symbol 9 supplied in a secure manner (physically or electronically) to an authorized end user. When the authorized user combines Symbols 9 and 10 (physically or electronically) the completed code may be read providing a complete amount of item-level information.

When Symbol 10 is combined and added to the Linear it would look like this: See Symbol 11.

[image]

Combined Symbology Symbol 11 would therefore scan (by suitably enabled bar code scanners or readers) as: 312345678906(17)040404(10)abc123. In sum, according to this one alternative embodiment of the present invention, the first and second parts of the second code (or even alternatively a first code for simplicity) may be physically separated (printed separately) and separately provided to an end user, preventing copying by counterfeiters and guaranteeing that only the authorized end user employing the separately-provided part of the second code could reassemble the second code for a successful scan.

In an example 6, another alternative embodiment of the present invention provides (e.g. a manufacturer) a portion of the continuous item-level data in a 1-D Linear code (a 1D symbology encodation) and continues said information in the Composite code thereby providing a security link that enhances the value and secure utility of the machine readable CS bar code. Thus, in the present example, if for example a manufacturer created a UCC/EAN-128 1-D Linear code with the start of a phrase: “Now is the time for” (See Symbol 12)

[image]

and subsequently added a Composite Code (2D symbology encodation) portion (See Symbol 13)

[image]

that contained the finishing phrase: “all good men”

and, physically (placing them adjacent) or electronically (through scanning code or programming) ‘re-constructed’ the original security phrase into a now machine-readable Composite Symbology (CS) bar code, it would look like this but remain unreadable without both portions. See Symbol 14.

[image]

In an example 7, where a 1-D Linear portion of a UCC/EAN-128 bar code contained the following portion of a URL. See Symbol 15.

[image]

This coded portion would scan as: www.anywebsite, but without the complete web address contained in the Composite Symbology mark as follows. See Symbol 16.

[image]

Similarly, scanning this part of the composite code will not create a URL that could access the correct site.

However, by physically or electrically re-constructing the ‘full’ composite symbology code, the ensuing code would look like this. See Symbol 17.

[image]

and this re-construction would (via scanning software programming) necessarily create a URL as: www.anywebcite.com/additional/secret and therefore be a “security enabled” URL contained in an enhanced and reconstructed UCC/EAN-128 with Composite bar code according to one alternative embodiment of the present invention.

In another alternative or optional embodiment of the present invention, it is envisioned that a portion of the code may contain a portion of a secure URL or secure URL accessing authorization in the 1-D Linear portion and continue the URL address into the Composite 2-D portion, enabling the creation of a secure and coded hyperlink to send a validated scanner unit or computer (employing the secure separated part of the code) via the hyperlink to a secure website on the World Wide Web for access to specific-item information. Since the Composite Symbology code is only readable when both portions are combined or electronically entered, an unauthorized user cannot access the web cite with only a portion of the Composite Symbology.

In an example 8, another optional alternative embodiment employing aspects of the present invention, dictates how important and/or life saving information may be added to a pre-existing UPC or EAN Linear bar code (it is noted herein, that any of the preceding embodiments may be similarly added to a preexisting label), maintained in confidence (according to the present invention) and be constructed/re-constructed by an authorized end user employing the missing code portion.

In the present alternative embodiment, a 1-D UPC-A Linear bar code contains numeric information about a product (for example a Candy Bar). See Symbol 18.

[image]

A manufacturer (of the Candy Bar) or end user (store) recognizing that it is critical to add important life-saving information to the product label creates an item-level numeric identifier (specific-item identifier), such as WARNING CONTAINS NUTS to the secure specific-item database in an encoded manner and creates a 2D Composite code containing this information as an addendum to the Linear code above. See Symbol 19.

[image]

An authorized user would then physically add or reconstruct the symbols to result in a ‘complete’ Composite Symbology code that can be scanned or read by suitably programmed scanners or readers. See Symbol 20.

[image]

In an example 9, according to another alternative embodiment of the present invention, an existing UPC or EAN bar code may be optionally “upgraded” into a secure Composite code to reflect, for example, a change in price after the item was finally priced and a UPC or EAN code label generated and applied to the product. See Symbol 21.

[image]

Here, a 2-D Composite may be created by an authorized manufacture, distributor, or end user is built to reflect the particular price change, e.g. 10% discount before Dec. 31, 2003. See Symbol 22.

[image]

This additional code may then be supplied to an end distributor or user (e.g., a store owner) and applied at various stations along the supply chain. As a consequence, an authorized user along the supply chain could securely re-construct the specific information in the following manner enabling the purchasing system in a store to recover the sales discount information and, linked with the purchasing system, charge a customer a revised price. See Symbol 23.

[image]

In an example 10, another alternative embodiment of the present invention provides an improvement for Human or Animal Drug information transfer (such as a newly discovered adverse drug interaction or information location for a pharmacist) would result by re-constructing the information that could exist in a bar code involving the UCC/EAN family of bar codes.

In a first event, an exemplary Drug company designs and creates an RSS 1D Linear bar code for a pharmaceutical item. See Symbol 24.

[image]

The drug company thereafter realizes important information must be added (during the manufacturing or shipping process) to the Linear 1D code in addition to the Expiration Date and Lot Number, but does not have sufficient room to apply a completely new code to a box or bottle, even where using a small-sized 2D Composite code. The Drug Company, therefore adds only a hyperlink to a designated web-page containing all the relevant information, but still keeps a small code-footprint. Thus, according to this particular alternative embodiment of the present invention, the 2-D Composite could look like this. See Symbol 25.

[image]

And when combined in a Composite Symbology in a completed RSS-14 1D linear bar code with a 2-D Composite that would look like this. See Symbol 26.

[image]

In this exemplary embodiment, this mark (Symbol 26) would scan as:(01)00300766446 www.acme.com/drugabc (17)040404(10)def567 and could still be readily adapted to several anti-counterfeiting or additional security measures as discussed elsewhere herein.

It should be understood, that as used herein the phrases reconstructed, constructed, recombined, assembled etc. refer to the practice of recombining portions of a separated Composite Code (either 1D/2D or 2D/2D) code and enabling access to item level or specific-item type information designated by a user and stored in an accessible and secure database.

Those skilled in the art will readily recognize that the present invention readily enables the construction, de-constructing and re-constructing of existing 1-D Linear bar codes with the addition or deletion of a 2-D Composite code and can thereby enhance the existing Linear UCC/EAN family of bar codes in the Public and Private sectors while adaptively positioning the completed combined code (Composite Symbology code) for secure separation.

Specifically regarding the non-RSS-14 family of UCC/EAN bar codes that can accept a Composite Component (CC) e.g., UPC-A, UPC-E, EAN-8, EAN-13 and UCC/EAN-128; it is noted that the group of UCC/EAN bar codes that does not require an encoded ‘link’ from the 1D Linear to add the Composite Component, is where at least one of the suggested alternative embodiments of this invention reside.

In another alternative embodiment of the present invention, a method is set forth allowing the storage of EPC™ type specific-item level information encoded in a secure Composite Symbology involving 2D bar codes and transmitting the information to an internet-based and/or intranet-based database in much the same manner as the expensive RFID tag for a fraction of the cost per EPC™, requiring minimal supportive infrastructure.

In this present optional and alternative embodiment, an exemplary manufacturer may conduct the following exemplary steps:

1. Identifying a product for manufacture and coding identification.

2. Determining the numbering system used, i.e.: UPC-A, UPC-E, NDC, UPN, EAN-13, EAN-8, EPC™, or other industry specific enumerators.

3. Enumerating (where needed) the prefix for country according to the numbering system.

4. Enumerating (where needed) the packaging level according to the numbering system.

5. Enumerating the designated manufacturer number according to the numbering system.

6. Enumerating the item by type, object, size, amount, transmission, lot, expiration date, or other higher-order information identifiers according an industry specific need, in the format of the numbering system selected.

7. Enumerating a unique specific-item designator (ex. serial number) for each individual item (ex. each pill, each dose, each unit, each person, each product, or other item depending upon the manufacturer's needs).

8. Incorporating the designated unique serial number for that specific item in a 2-D bar code, either encrypted or not, or optionally requiring or not a hook or link in the 2-D code to a second code (1-D) code to enable scanning/reading of the combined 2-D/ 1-D code, and decoding scanning/reading of the 2-D code by itself.

9. Applying that 2-D bar code to the product by commercially accepted offline or online printing methods producing a scannable 2-D bar code.

10. Generating a linked security 1-D bar code enabling reading of combination of the scannable/readable 2-D code and the 1-D code (for each designated supply chain individual) only when joined physically or electronically joined during the scanning/reading process.

11. Maintaining a secure database of each item and its unique specific-item identifying numbers, 2-D bar code, and authorized (linked/hooked or unlinked/unhooked) 1-D bar code.

12. Maintaining that database on in-house or on the World Wide Web for supply chain tracking or other tracking purposes (i.e. delivery or return purposes) for authorized supply chain partners, with access to the World Wide Web via computer and appropriately programmed scanners enabling access only through the use of the authorized 1-D bar code during joint/combined scanning with the unique 2-D bar code.

13. Allowing for updating the location or change in Composite Symbology makeup or amount of that specific labeled item by authorized opt-in supply chain partners using the authorized 1-D code with access to the World Wide Web when combining/recombining/decoding the 2-D code with the secure 1-D bar code.

14. Enabling the certification of pedigree of that specific item from initial labeler or manufacturer to end user (and during an optional return or recall practice) via computer and an appropriate connected or wireless scanning or optical code reader with access to the World Wide Web. Where along each step of the supply chain the unique 1-D bar code limits access to the database when not scanned in conjunction with the authorized 2-D bar code or through another authorized Internet forensic method of access (e.g., secure passwords, fingerprints, voice, eye, DNA scans etc.)

In another alternative embodiment for ensuring the security for uniquely identifiable products, a manufacturer may follow the steps of:

1. Identifying a product for manufacture.

2. Determining the numbering system used, i.e.: UPC-A, UPC-E, NDC, UPN, EAN-13, EAN-8, EPC™, or other industry specific enumerators.

3. Enumerating (where needed) the prefix for country according to the numbering system.

4. Enumerating (where needed) the packaging level according to the numbering system.

5. Enumerating the manufacturer number according to the numbering system.

6. Enumerating the item according to the numbering system (by type, object, size, amount, transmission, lot, expiration date, or other identifiers according industry specific need, in the format of the numbering system used).

7. Enumerating a unique specific-item designator (ex. serial number) for each item according to a designators determination of item-specific information.

8. Incorporating the unique serial number for that specific item into the 2D Composite part of an RSS bar code, i.e.: any 2D symbology or composite symbology for example a-RSS Limited, b-RSS Stacked, c-RSS Truncated, d-RSS Expanded e-RSS-14, etc.,

or in other optional and alternative embodiments into the 2D Composite portion of: an e-UCC/EAN-128, f-UPC-A, g-UPC-E, h-EAN-8, i-EAN-13 or other code.

9. Applying that 2D bar code to the product by commercially accepted outside or inside offline or online printing methods that would reproduce a scannable bar code (but for any intentionally created scanning prohibitions).

10. Maintaining a database of at least each designated item and its unique identifying item-number and designated 2D Composite bar code.

11. Maintaining the database on the World Wide Web for authorized-user supply chain access and tracking for authorized supply chain partners provided with secure access to the World Wide Web via computer and appropriately programmed scanners or readers.

12. Requiring that supply chain partners securely-retain the secure and designated one-dimensional (1D) or Linear portion of the appropriate 2D bar code used on the product, without which, the information in the 2D Composite cannot be read (1D and 2D portions are electronically hooked together).

13. Allowing for the (optional) inclusion in that Linear 1D bar code of supply chain partner specific information about that partner for identification or tracking purposes through globally recognized or trading partner agreed-upon Application Identifiers (ex. (10) for expiration date but other identifiers may be optionally selected).

14. Including in specially pre-programmed bar code scanners (or other electronic reading systems) that authorized supply chain partners are in possession of a designated URL for a specific (optionally access-restricted) web address on the World Wide Web for accessing the information storage and accessing database.

15. Allowing supply Chain partners, with pre-programmed scanners attached to a computer with access to the World Wide Web to scan the reconstructed combined 1-D and 2-D Composite bar code (Composite Symbology).

16. Optionally allowing for the utilization of computer CPU designation authorization via an Application Software Platform linked to a specified server on the World Wide Web hosting or providing access to the secure or master database or system (e.g. the designated CPU designation provides an optional additional level of security).

17. Optionally allowing for the authorized access to specific and secure website(s) for purposes of authenticating the pedigree of a specific product along a supply chain tracked via the master data system (alternative called in some embodiments an authorized-use accessible storage system)

18. Requiring Log-in authentication of supply chain partners by (in this alternative embodiment) scanning at least a form of scannable identification (optionally in addition to other authentication features including passwords) so that the master data system can track which identification is used to access the data system.

19. Requiring entering of specific-item or item-specific information relating to the item being scanned (via hand entry where the physical code label is damaged or by scanning/reading in a manner discussed above).

20. Optionally allowing for comparing entered item data to the item information stored on the database.

21. Optionally allowing for updating the location or other change to the specific-item information (e.g., item or amounts, strengths or other identifiable changes relating to a specific item) of that specific item by authorized supply chain partners with access to the World Wide Web via computer.

22. Recording the entry of each specific item for each authorized supply chain partner whereby a report of such authorized entry (or report of rejected unauthorized attempted entry) and partner provides a certifiable pedigree chain of that a specific designated item from the specific manufacturer to end users via computer with access to the World Wide Web.

As used herein and elsewhere, the phrase product and/or items should be understood as a word-label used by a manufacturer in a particular circumstance. For example, a drug company may use the phrase “item” to identify a single dose (1-pill or 1-ampoule) of a drug but may simultaneously use the phrase “product” or “item” to identify a single package containing a single drug product (1-pill or ampoule) or several drug products (10 pills). Alternatively, a shipping company may designate tracking an “item” or a “product” as a pallet containing multiple-packaged items (products) designated as suitable for item-specific tracking purposes of the shipping company.

As also used herein the phrases data base, storage system, or internet data base or controlling system or managing program should be generally understood to represent a type of software (and optionally including hardware) system capable of maintaining a secure and authorized-use accessible data base or storage system (either on the internet or within an intranet or elsewhere) effective to act in any of the manners described herein (i.e., receiving and storing item specific designations, encoding these designations, printing labels and encoded portions of an encoded item specific designation, updating along the supply chain, issuing pedigree, tracking, and authorized user reports, or counterfeit, stolen, or lost goods reports, tracking access, updating information, rebuilding damaged Composite Symbology labels etc.)

In a combined alternative example, a drug company may generate an “item a” identifier (e.g. specific pill/pill), a “product a” box identifier (e.g. box of 5 ampoules/pills), a larger “product b” box identifier (e.g. a box containing 10 boxes of 5 ampoules/pills) and a shipping company may designate an “item b” identifier (e.g., a single pallet containing 50 boxes of 10 boxes of 5 ampoules/pills). Each of these serialized numbers may be tracked/linked with shipper/manufacturer or third-party databases or a master data system for tracking along the supply/return/delivery/loss/recover chain depending upon a particular parties' and partner's tracking needs.

In sum, it should be recognized that the instant system or methodology is readily adapted to via variety of uses and methods across a spectrum of business and business systems depending upon where, when, and how the methodology is implemented.

As a consequence, and due to the variable nature of the English language and the variation of designated tracking identifiers across multiple industries, where the present descriptions use the phrase “item” or “product” or other identifying label, it should be considered a general or descriptive label unless a specific example (pill, bottle, container, person, syringe etc., or a particular industry restricts the meaning.

Referring now to FIG. 1, one optional and alternative method for practicing aspects of the present invention is described employing at least one safety and security feature of comparing a chain partner's computer CPU identifier with an accepted identifier in the secure database or separately issuing a component of a Composite Symbology code to an authorized partner.

In the present method, in a first step 1 a manufacturer makes a decision to identify a “product” or selected specific “item” and in a second step 2 assigns and designates an item specific numbering system providing a specific 1D containing all the information the manufacturer determines should be tracked for that specific “product” or “item.”

In a third step 3 the manufacturer assigns a unit specific serial or designated number to the product and in a fourth step 4 authorizes a designated party to create a 2D composite bar code for that particular item or product in a known selectable type of composite code system. An example of a 2D composite bar code is provided.

It should be understood, that this 2D composite bar code may optionally include coded “hooks” requiring simultaneous scanning or electronic “reading” (with a data base system) a linked 1D bar code to complete a scan and access the product/unit data base list.

It is also optionally acceptable that the 2D composite code does not include “hooks” and that instead, accessing the product/unit/item data base requires scanning a verified and authenticated 1D or 2D code to gain access to the data base system in conjunction with scanning the 2D code, thereby preventing authorized entry of the scannable 2D code without having previously accessed the data base via the non-hooked 1D/2D code.

In a fifth step 5, the bar code is printed through commercially accepted printing methods, either off site or on site (manufacturing location), including but not limited to methods such as flexographic, letter press, ink jet, laser, thermal, or other non-enumerated printing method.

In a sixth step 6, through a scanning program on-site, the 1D or 2D or combination of both are scanned and the serial numbers stored in a master data system. In the case of an individual item, the label is then applied to the product or package. In a case where a label to be printed for a multi-item container is used, each item label is scanned and when a preset amount is reached, the scanner sends a signal to a down stream printer for the generation of a label with the corresponding information including all of the item-specific numbers (e.g., serial numbers) included in the box, carton, pallet, container or other packing to be applied to the designated container or packaging.

In a seventh step 7, the designated item, label, or package is then shipped to a supply chain partner wishing to securely verify both the receipt and of the authentic nature of the item/product. In this example, the supply chain partner has already generated or received a secure 1D or 2D partner specific bar code linked in the manufacturers or other's master database including the specific-item information and optionally linked to a designated partner/user/employee/specific scanner or CPU etc.

In an eighth step 8, the supply chain partner physically holds (or electronically combines) the partner specific 1D bar code (one example shown) adjacent the 2D composite code thereby physically (or electronically) reconstructing in step 9 the complete scannable composite 1D+2D bar code (Composite Symbology code). The combined codes are shown in representation.

In step 10, the complete 1D+2D bar code is scanned with a scanner containing or linked with a computer containing a specific access mechanism (e.g., secure URL address for accessing an internet database). In step 11, the supply chain partner's scanner's CPU identifier tag (unique to each CPU) is compared by the master data system to an authorized user's CPU tag and accepted or rejected (this is one optional additional security feature).

In an optional step 12, the supply chain partner is then prompted to log-in verifying information (via key board or additional bar code scan) and is accepted or rejected (an additional optional security feature). In step 13, where the supply chain partner is verified, the combined 1D and composite 2D bar code information is entered (physically where a label is damaged or electronically scanned) into the secure database system and compared to a manufacturer's authentic item/product information.

In a final step 14 the data base system then renders a determination/authentication regarding the item/product and the user and may optionally generate a pedigree/approval/rejection report or electronic notice comparing the received information and the stored information and (if authorized) optionally update the database information and location of the item/product at the supply chain partner.

Referring now to FIGS. 2A and 2B, one alternative embodiment of the present invention is described employing a designated unit/item/product label 20 and a supply chain authorized employee identification badge 21. In this embodiment, a database or master management system is subsumed and linked with the Internet or other means (internal or external to a location) to an employee workstation employing a scanner/reader. In this alternative embodiment, label 20 is optionally placed on a single bottle of a product (SuperDrug™) containing 100 tablets each of 25 mg. It is envisioned that in alternative embodiments, label 20 may be modified depending upon a manufacturer or suppliers' needs (e.g., a pallet identifier for a shipping company, a single container for a container company, a cosmetic container or package, or a single tablet or single syringe or injectable ampoule for a drug manufacturer).

Label 20 includes a first manufacturer-specific composite 1D/2D general identifier bar code portion 22 covering, for example the NDC and expiration information (including duplicate readable portions) and a second split or de-constructed item-specific 2D security composite bar code portion 23 requiring a “hook” or linked code to enable actual reading of code portion 23.

Identification badge 21 includes a supply chain partner composite code 24 securely identifying the employee. Here, it should be recognized that supply chain partner code 24 is optionally created by the partner for internal tracking of the employee or for other uses determined by the supply chain partner. One example of using code 24 would enable the employee to access a protected computer/CPU in a shipping/receiving location or pharmaceutical lab location, and to operate that computer to log-in or log-out specific received or returned items.

Identification badge 21 additionally includes the 1D bar code 25 that is the second half of the split or de-constructed security composite code portion 23 in label 20. Code 25 may be optionally individually readable (without composite code portion 23) or not depending upon the preferences of the manufacturer, the designer of the secure tracking system, or the supply chain partner. In the present example, bar code 25 is a single readable 1D linear code “hooked” to composite code portion 23.

In use, the employee physically places an edge 26 of badge 21 and specifically 1D code portion 25 closely adjacent 2D composite code portion 23 and then holds a scanner (not shown) in a position to read both 1D code portion 25 and code portion 23 at the same time. The authorized employee then scans the now physically re-combined composite 1D/2D bar code. Since the physical combination of codes enables the scanner to actually scan the combined codes and interpretation of the code language, where either code portion is physically missing code portion 23 cannot be read.

In this embodiment, since code portion 23 cannot be read without authorized code portion 25, and since the combination of code portions 23/25 are specific to an individually designated item/product enabling a database to be updated only a single time and rejecting all other attempts, where code portion 23 is duplicated and re-scanned (by a copyist, infringer, or in error), the manufacturer's and supply chain partner's database will reject the item/product scan as a counterfeit, infringing, or previously scanned item and notify designated individuals according to an optional programming loop. In this manner, the pedigree and authenticity of a single item/product may be protected and consumer confidence or patient safety improved.

In an adaptation of the present alternative embodiment, an underlying security and authentication system enables an electronic or printed flag to be provided to designated individual upon the entry or attempted entry of a scan. In this manner, where a manufacture reports lost or stolen items, the data base flags those specific items, and if the items are rescanned in an unexpected location or by an unauthorized supply chain partner the system will reject the attempted scan and report the attempted counterfeit to the manufacturer.

In another adaptation of the present alternative embodiment, an overt type (custom developed for a particular location) authentication system or means tracks a specific employee entered-access time and location on a master control system and also tracks individual scanning events and links to the authorized item data base. As a consequence, where unexpected scans occur, the over system can track and record a particular scan to a particular individual and location.

Referring now to FIG. 3, another alternative method for practicing one aspect of the present invention is visually described in reference to an individual designated item/product packaging code combined with a second individual (multiple item container) designated code at a manufacture. In this alternative embodiment, a master data and access/control system 10 either generates individualized numbers for each product as the products are created via an electronic assembly line link (not shown) or via human input and generates a list of unassigned individualized numbers awaiting assignment to a specific items or products undergoing production.

It should be understood by those skilled in the arts of process and production control, that while one alternative scenario and method for the present invention is shown in FIG. 3 additional alternative embodiments are considered without departing from the scope and spirit of the present invention. For example, master data system 10 may additionally include process control systems and links to any of the selected items (1-10 or other common processing items not shown) that functions actively to control a speed and action of the process labeling, recording, scanning, and coding process itself in addition to monitoring and recording code identifiers. As a consequence, it should be understood that system 10 may be selected from a plurality of systems capable of both the minimal steps discussed below and the much broader opportunities available in active process control systems, and as such may include additional established electronic links (not shown) and additional control or monitoring modules.

As shown in the present alternative embodiment, in a first step a roll (for example) of labels 1 is placed onto a packaging line and a scanner 2 regulates movement of the labels into a labeler 3 where the product is labeled with a readable 1D label as the product passes by. It should be noted, that where the item designations are pre-created off-site there may (optionally) be no need to link labeler 3 to a master data system 10; however, where the item designations are created in situ there may be a link (not shown) between labeler 3, scanner 2, etc. and master data base system 10. It should be noted that depending upon a manufacture and type of process control involved, each step or element may be combined with a master data base or master control system to both manage secure labeling and the production process.

After labeler 3 applies a label, a scanner 4 in optional communication with master data system 10, regulates the passage of the product/label combination under a printer or to print head or mechanism in a conventionally known method of printing 5 which either prints a coded specific-item information (e.g., serial number) in a bar code format (with or without human readables), and/or prints an individualized serial number (item identifier) specific to that product into the existing 2D composite containing other identification such as, but not limited to lot/batch, expiration, quantity, etc. Optionally both scanner 4 and printer 5, or even the process control machinery itself (not shown), may access or be controlled by a master data base system linking each product to each label and to each bar code generated in the process. In another optional embodiment of the present invention labeler 3 prints a designated item code on the label prior to application to the product itself.

As the now-labeled product passes through a scanner 6, the label and code is linked with the master data system 10, which reads and records the pertinent individual item data to the master data system 10, including the designated serial numbers and, after a pre-arranged amount of product passes by, master data system 10 signals this item-specific information (manufacturer number/NDC etc, product information, lot or batch number, and the first and last serial number) to the down-line printer head 7 (also linked with master data system 10).

Printer 7 prints a label for a now-full package (this now-full package (item) label number is also recorded in master data system 10 linked to the individual item numbers). The label is applied to the package containing the individual items/products and a packager 8 accessing the now-full package closes and seals the package and sends the package down-line to a scanner 9 that scans the full-package label and records the box number in the master data system 10. In additional steps (not shown) when a sufficient number of full-packages are placed on a shipping pallet or in a shipping container a printer 10 prints a pallet-specific bar code incorporating or linking in the data base all the previous codes (full-package items and product-items) and with corresponding serial numbers therein. This last label is then supplied to the sealed pallet containing all the boxes and items/products.

It should be additionally understood, that in the embodiment described, the present invention easily mimics the multi-level item-specific capacity of the more expensive and presently-unworkable RFID system providing substantial cost savings and eliminating the detriments of the RFID system noted earlier. Additionally, the present system, establishes the present practice of multi-level specific-item information tracking (and the supportive data base systems) that must be in place throughout a designated supply chain for a comprehensive transition to the RFID system in the future.

In this alternative embodiment, a manufacturer can scan the entire coded pallet label identifying (via secure data base linking) all the individual serial numbers prior to shipping and record their exit from the manufacturing plant in a manner to that similarly envisioned by the RFID system without the required added infrastructure.

A shipper can scan and record the pallet serialized 1D number and record receipt in the data based linked with the manufacturer. The shipper opens the pallet and then scans each individualized box or item/product as it is delivered in a manner linked with master data system 10, another designated system (on the Web), or not depending upon a shipper's desire.

The authorized receiver or end user then scans the pallet level secure code acknowledging each individualized box or item/product upon receipt via the above described process in a manner linked with the master data base thereby receiving authentication and verification that the items/products received were actually manufactured by the manufacturer and have a pedigree. In sum, at least one embodiment of the present invention serves as simple pedigree verification means allowing a single authorized scan to record each individual product in or on a pallet or other container.

In another alternative embodiment, where the authorized receiver repacks selective boxes for re-shipping to other supply chain partners the master system may optionally provide another way to print and secure additional supply chain master labels linked with the master system. In this way, when secondary-level revisions are made the present invention allows an additional level of security for the additional supply chain partners enabling secure and authorizing scans of individual product codes in a single scan. Finally, where end users open individual boxes, via secure links to the master database and employing designated and secure coded information, an authorized user may scan an individual item/product and provide proof of receipt to the original manufacturer or receive information regarding the original manufactured product, including for example, original amounts, strengths, lots, expiration dates, NDC, or other identifying enumerators.

In sum, the present invention is easily adapted to a wide variety of scenario's adaptable across the broad range of manufacturing/shipping/market and levels (e.g. pharmaceutical, manufacturing, recall, governmental tracking (visa/passport/driver license), quality control, event tracking, human control systems (prisoner, jail, employee control systems), medical systems (clinical trials, vaccine tracking, drug administration systems) international and national shipping systems (FedEx, USPS, UPS etc.), and manufacturer-supplier to multiple additional supplier to customer level changes).

It should be noted that while previous discussion included reviews of 1D and 2D encodation schemes and combinations in Composite Symbologies, users of the present invention may create non-recognized customized format for a particular encodation scheme, these customized formats would generally follow 1D or 2D encodation schemes but place custom designed designated identifiers in customized positions within the scheme preventing reading/scanning by unauthorized users.

One possible alternative serialization scenario of one embodiment of the present invention may optionally include the following steps:

a. Manufacturer pre-prints a label offline with a commercial printer, or in an inline setting prints any encrypted 2D Composite bar code (2D symbology encodation) like this Reduced Space Symbology (RSS) Limited Composite:

[image]

b. The information contained in one embodiment would contain any ‘product’ or ‘item’ identifying data or specific item information in a globally recognized format or optionally a non-recognized customized format may be used specific to and created by a particular worldwide manufacturer and agreed to by its trading partners. (e.g., General Electric or Pfizer).

c. The Label is applied to product and shipped. Receiver would need a corresponding (1D symbology encodation) here a RSS Limited Linear bar code with the appropriate ‘hook’ electronically built into the code for example this:

[image]

to complete the entire information encoded. This bar code may be optionally placed electronically in a scanning system, on a user ID badge (See e.g., FIG. 2B), or on a designator capable of being combined and scanned with the above RSS limited composite.

d. The completed code when combined in the alternative manners described would look like this:

[image]

and would reveal the completed data (both higher order information and specific item information) when scanned or read by appropriate scanners or readers optionally accessing a secure database.

Yet another possible alternative serialization scenario of one embodiment of the present invention may optionally include the following steps:

(a) Manufacturer pre-prints a label or, in an online setting or manufacturing setting, prints any encrypted 2D Composite bar code (2D Symbology encodation) like this Reduced Space Symbology (RSS) Limited Composite, which in this example looks like this:

[image]

(b) The information contained in this present alternative embodiment (as shown above) would contain (for example) a ‘hashed’ National Drug Code (e.g. a 10 digit code including designations for manufacturing company, drug type, strength, and/or transmission means or type, and serial number etc.)

(c) The label is then applied to a product, accounted for according to a manufacturer's practice and shipped. A corresponding RSS Limited Linear bar code (1D symbology encodation) (retained by the authorized and designated receiver) is physically held proximate the 2D Composite and a pre-programmed scanner or reader containing either a prefix or a suffix completes the scannable information within both labels as a string, or optionally be programmed to create a hyperlink to a prearranged and custom designed Application Software Platform on the World Wide Web for further decoding and linking with a master data base to authenticate the label and product.

A third possible alternative serialization scenario of one embodiment of the present invention may optionally include the following steps:

(a) A Manufacturer pre-prints a Composite Symbology label (on-site or off-site) containing the (in this example) a National Drug Code, Lot and Expiration Date and a designated individualized product or item Serial Number (either in a sequential, numeric, or random alpha or alpha-numeric manner or optionally encrypted manner) in a bar code like but not limited to RSS Limited formats, that would be machine readable and optionally contain human readable references like this:

[image]

or this

[image]

(b) The product with the label is then shipped to a receiver.

(c) When received an appropriately pre-programmed scanner or reader parses out the relevant data into data fields, for example like this: NDC 0006987654 Lot XYZ123 Serial Number E5E or 01234567890 and scans these fields them into relevant data fields in a master data base linking the authorized shipping label with the authenticated receiving label. Alternatively, where the label is no longer machine readable, an operator may access a secure master data base and hand-enter the human readable references to re-create the secure symbology label for later scanning and use.

It is additionally envisioned that one possible embodiment made capable by modification of selected features or aspects of the present invention applied to alternative customer needs may provide an RFID/Electronic Product Code (EPC) transition by utilizing selected futures of the above described inventions as a bridge to the future RFID/EPC type systems developing within the next decade.

As an additional alternative aspect of the present invention a management group may develop privately and provide as a service an Electronic Sequence Code (ESC™) to serialize products at an individual, case, pallet, container or other level and provide an accessible Master Data Base and Authentication system. In this alternative embodiment, an outside user would request or generate a designated number of “item” specific codes for use as labels and secure them employing one of the authentication processes discussed above. As the items are shipped, moved, sold, lost, counterfeit etc., authorized users would receive authentication pedigrees from the linked system confirming origin and transport steps. Unauthorized users would receive no confirmation and would be, in some aspects, unable to scan or process the labeled product.

As aspects of the present invention presently offer unit-specific codes, for example for verifying tracking and providing a pedigree for an individual's prescription or OTC (over the counter) drug product with specific NDC (national drug code), Lot number, Expiration Date, serial number etc. information), etc. it is envisioned that those in the pharmaceutical industry would particularly employ the present invention in one of it's many aspects.

In another aspect of the present invention, those skilled in the art will recognize that additional levels of scrambling and other types of secure technology may be applied to the secure data base and control systems provided with alternative embodiments of the present invention.

According to another aspect of the present invention there is optionally provided a secure application software platform, a bar code engine, or other device or systems enabled to conduct at one of the optional actions noted above, including sending to authorized users electronic files of any 1D or 2D globally recognized bar code combinations or encrypted representations of same separately or together to a suitably configured commercial printer (on-line/stand-alone).

As noted, a secure application software platform and bar code engine may be adaptively considered as or adapted to work within at least one of the optional systems and methods described herein. For example, a bar code engine or software platform may be optionally programmed conduct the steps necessary to accomplish one of the alternative embodiments of the present invention or to determine selective steps performed by one alternative embodiment of the invention. For example, a bar code engine or software platform may be designed to optionally include steps of (in one alternative embodiment of the present invention) enumeration, encoding, printing or other steps as discussed herein, or any one of the steps individually depending upon a users particular system, apparatus, or method of use where off-the shelf and/or custom designed hardware and software units may be adaptively joined in a ‘system,’ ‘platform,’ or ‘engine’ in a manner effective to achieve at least one of the alternative embodiments noted herein.

As noted herein the descriptive phrase enumerating or enumeration is to be broadly interpreted as deciding upon or determining or selecting an identification system or numbering or code scheme of any kind according to and optionally including any of the 1D, 2D or Composite bar code systems noted herein. This enumeration may additionally include the generation of a custom-designed identification system determined and agreed to by users of the identification system but presently not standardized by the UCC/EAN organizations. In one alternative example, a particular enumerated item specific designation is encoded into a Composite symbology encodation containing both a RSS Limited Composite bar code and a RSS Limited Linear bar code.

As also noted herein the phrase item specific designation may optionally include information of one or both of a higher-order-type information (ex. NDC, country code, manufacturer etc.) and a specific-item-type information (e.g., serial, item, product number etc.) depending upon a user's desire for security features, and may be immediately readable or initially encrypted and readable only at a first initial encrypted level requiring a later second additional decryption to finally read the specific item information.

It is also noted herein, that as used composite symbologies may include 2D symbologies that are themselves composite symbologies. For example, where a 2D symbology is a RSS Limited Composite (a first type of composite symbology) and is joined with a 1D RSS Limited Linear code, the combined “composite symbology” includes the initial RSS composite symbology already, thus the phrases 2D and 1D are used descriptively.

The above noted descriptions and incorporated disclosures characterize a review of the various types of 2-dimensional composite and linear (1-D) bar code symbologies, composite encodation strategies for secure and serialized identifiers, and suggest methods and systems for combining and manipulating the same within information management systems along distribution streams as invented by the applicant to benefit a consumer of any size along a supply chain.

However, due to the enabling disclosure as well as the novel improvement claimed herein, it is additionally proposed that the presently described static or preexisting encodation systems, even the encodation system discussed above are thus capable of now including variable data with “static” data in intra-networks, extra-networks, and secure data systems accessible via the internet.

As discussed herein “static” data is that data, at least basically descriptive and preferably encoded and secure serialized data produced by the suggested serialization process to identify preferably a singular unit or group of singular units from a manufacturer at the beginning of a supply chain or distribution chain.

It will also be appreciated, that the present invention includes the teaching of additional “variable” data encodation employing 2D or 2D composite encodation schemes linked to a supporting secure data network and linear encodation information systems as discussed.

As used herein “variable data” is broadly considered “new” data determined as necessary by a user along a supply stream to include in a product description/warning/detail, etc. that occurs after initial product encodation at an initial manufacturer serialized, composite, or otherwise. The inclusion of variable data with preexisting static data is particularly enabled by using composite type symbology of the type described above, and retains the optimal use of comprehensive security measures discussed above employing a construction/reconstruction processes.

As envisioned, the method and system enables the generation of new and 2 dimensional composite bar codes that are encoded and linked to selected static or preexisting encodation products (linear bar codes or composite encodations) and allows the link to the new data. These new codes, after generation are applied to preexisting products and similarly scanned upon processing and transportation, providing an additional variable data information link. For example, a product is initially produced with an encodation scheme at an origin—that encodation scheme being linear, 2D, composite, serialized, etc., wherein that initially produced encodation is modified downstream by the inclusion of an additional label incorporating variable data, either on the physical label, or linking the individual item to new data within a data management system.

The processing discussed herein is a transactional type of processing wherein the identified product is scanned in a variety of ways or at a number of different steps along a supply chain.

In one example of a transaction involving the present method and system, a supplier delivers products to a retail customer, and upon receipt the product (or multiple products) their “static” data (serialized or otherwise) is scanned into the retail customer's data bank and entered in inventory with an associated receipt report in the inventory management system. At this point, the “static” data printed on the product or package is envisioned to be protected by the secure encodation process discussed above as an enabling example, but such an encodation process is not always mandatory as previously known identifying data printing systems may be employed. This type of transfer may be modified to include the addition of “variable” data to the known static data.

In another example of a transaction suitable for the present method and system, an item transfer (or multiple item transfers) occurs within an associated manufacturing facility or between shipping facilities wherein the transaction is linked to a scanned possession transfer, either for further packaging, transshipping, or processing steps. Other types of common transactions understood by those of skill in the wide number of transactional arts are intended to be incorporated herein. In broad terms, a transaction as used herein means a transfer where information relating to a product or products is also transferred in some way to track the transfer of the product and update a computerized system.

The present invention involves the linking of variable data that includes “useful information” processed through the transaction process with the static composite code and linear code scanning and data access information previously associated with an item.

As a practical example, a product (a bag of snack food) is initially identified by an encodation scheme, preferably in a serialized maimer employing a secure encodation scheme at an initial point in a supply stream. Thereafter, the product is provided to a wholesale distributor along a transaction path. The product includes a conventional or encoded bar code linked with static information. For example, the bar code may be a UPC bar code, identifying manufacturer and type of product, or may be a particularly secure serialized code as discussed above.

At this transaction or transfer point, the manufacturer or another determines an amount of “useful information” (variable data) such as the need to include a warning that the product “Contains Nuts” should be electronically linked to the product.

A 2D or composite label is generated by the distributor and newly applied to the product, wherein the 2D composite label is electronically linked with the conventional or serialized bar code in a “composite” manner (meaning the entire code is comprehensively readable) and is linked with a system message “warning contains nuts” as a variable data set with a secured data system as noted above. This linking within a master data system, allows the accessing and delivery of the variable data when the conventional bar code or 2D composite code are scanned in a composite manner with the new label.

The product is then provided to an end retailer in a further transaction and upon receipt, the static (and optionally the variable information) is transferred to the end retailer's system for display upon purchase, and may be easily updated within any form of managing internet-based data system.

Thereafter, during a purchase transaction by an end user, a retail clerk scans the now 2D composite code (linking the static data conventional or composite bar code information and variable data (stored either within the retailer's system or within a macro internet-based data system described elsewhere herein)). Upon this access, the sales receipt generation system may be programmed by to print the variable data (or a subset of the variable data and static data) on the sales receipt as, for example, a customer warning that the product contains nuts.

In this manner, the present method and system enables the transfer of a set or a subset of variable date (for example a content warning, transfer pedigree notice, or authentication code etc.) through the transaction process to warn a customer. Such an update step may be conducted at any point throughout the entire supply chain transaction process.

Based upon the disclosure provided herein, alternatives of this system are envisioned and include the use of variable information to include additional sales information (coupons, warning labels, use information, authentication information, web-site access information for promotional use, environmental information, etc.) in addition to any static data (either common UPC information or more complex serialized product data)

Also, the “printed sales receipt” during transfer noted above may be understood to also be a physically printed document—printed from any conventional or to be developed type of printing system (fixed or mobile), an electronic email message display, an electronic facsimile, a data transfer within a single data system (e.g., a sales data system) or between two different data systems (the retail system and an internet based system), the generation of a printed, electronic, verbal, or visual warning or reminder on a computer screen to be read by a user, or any other type of information transfer of the accessed variable information linked by the 2D composite code with the conventional or other encodation label previously provided on the product.

The types of variable information capable of transfer employing the present method vary by process (printed, emailed, faxed, verbal, etc.) and by content (a content warning, pedigree notice, a request for the sales person (in printing, as shown in the computer screen, or in an audible cue) to notify the patron of a portion of the variable data.) For example, a sales person having scanned the now composite static+variable data encodation, may receive an electronic system cue to say; “Sir, do you understand that this medicine may cause drowsiness and should be taken with food”. Similar messages may be relayed regarding pedigree certification, authentication and validation information, coming sales, or any other types of variable data that a transaction system user may wish to link to a particular transaction product.

In the context of an inventory transaction, the variable information transferred may include a vast amount of individual unit information as listed in and described in the incorporated applications, and in addition may include a portion of the information in a “printed receipt” (visual, audible, paper, electronic, etc.) format. In one example, the variable data may include in such a “printed receipt” upon inventory transfer, a formal certificate of authenticity or a pedigree report of the product from the previous transfer stages and manufacturer, that may be physically or electronically stored for later access.

Alternatively, the variable information may include later data from a manufacturer that the product being transferred down stream needs to be stored within a certain temperature range (“Warning-must be stored below 50 degrees Celsius. Do not freeze”), and this warning may print upon the transfer-bill of lading-shipping notice following inventory transfer. Similar warnings could include a maximum acceptable acceleration (g-force) without damage, or a must-sell-by date previously unascertained during manufacturing.

The present system and method may be employed within a hospital to ensure current information is provided to the administrator of drugs. In this example, a Hospital may have a drug already in inventory, which includes a linear bar code with static preexisting data. Employing the present electronic system and method in a manner disclosed in the incorporated references provides a composite 2d code linked with the linear bar code and the system information now includes individual product information and “variable data” including particular administration instructions (“inject only intravenously” or “this prescription is only for patient Jones”) or particular use instructions (“this product must be consumed immediately after meal”). This individual product information (with variable data) may be printed on the Hospital pharmacy patient receipt, or on instructions provided upon a nurse picking up the prescription. This information may be visually displayed on a medicine administration computer system or transfer station upon prescription order, or in other ways to draw the caregiver's attention to the variable data necessary to increase safety.

As should be understood by those of skill in the selected art, the present invention involves the use of computer programming, electronic data base control, employee training and other steps necessary to achieve procedural changes along a supply and sale/use transaction chain.

The present invention provides many principal benefits. These benefits include (a) the reduction of legal liability (by providing timely warnings (written-visual-audible) particularize-able to a product, (b) the adaptation to newly understood information via new labeling on products on store shelves or in other inventory with the composite code keyed to the variable data otherwise linked with the preexisting static data, (c) the transfer of liability (by providing a clear notice and instruction to an end retailer to inform customers that the product “contains nuts” or “should be consumed with milk”, etc.) throughout the supply or transfer chain after each transfer (manufacturer to re-packager to transshipper to shipper to a whole seller, to retailer, to customer etc.), (d) the provision of a product/shipment authentication notice or pedigree receipt for a particular unit, (e) the linking of a patient to a prescription, and many more.

Applications for the particular invention and use of a method and system for employing, modifying, and adding variable type information during a transfer or transaction involving the serialization of products utilizing bar code technology with combinations of linear and/or composite parts together or separately, and/or in conjunction with Radio Frequency Identification (RFID) include applications for anti-counterfeiting measure, for use in re-calls, for identifying legitimate returns, to identify where parts were manufactured, to identify when parts were manufactured, for use in contests and/or lotteries, for overt or covert marking purposes for uses such gambling paraphernalia identification, as stamps or mailing material, for even event tracking, such as sporting or entertainment where tickets are issued with new variable information in addition to previous static information, for clinical trial monitoring and tracking, for test grading, for quality control, for passport and or visa control, for Drivers license security, for the tracking of products along in a supply chain, for vaccines tracking, for blood or biological product tracking, for prisoner and jail control, and other reasons. In each step, new labels may be generated and applied to a product, or where a product is already encoded with a serialized identifier (item specific), only the electronic record related to the specific item may be updated with the variable data.

It should be additionally obvious to those of skill in the art of product identification and RFID transactions, that RFID tag are one form of serialized identifier. In situations where supply/distribution stream users are not all suitably equipped to employ RFID reading technology the present invention may be employed. For example, an RFID user may scan an RFID labeled product and print a serialized composite label to physically place on the product. This composite label may optionally include human readable character's or simply a numeric stream as discussed above. Since downstream users (without RFID equipment) may employ composite bar code readers on the now-labeled product they may seamlessly integrate RFID labeled products into a supply stream that is not fully RFID-enabled using the disclosed method and system with programmed computer systems.

In the claims, means- or step-plus-function clauses are intended to cover the structures described or suggested herein as performing the recited function and not only structural equivalents but also equivalent structures. Thus, for example, although a nail, a screw, and a bolt may not be structural equivalents in that a nail relies on friction between a wooden part and a cylindrical surface, a screw's helical surface positively engages the wooden part, and a bolt's head and nut compress opposite sides of a wooden part, in the environment of fastening wooden parts, a nail, a screw, and a bolt may be readily understood by those skilled in the art as equivalent structures.

Although only a single or few exemplary embodiments of this invention have been described in detail above, those skilled in the art will readily appreciate that many modifications are possible in the exemplary embodiment(s) without materially departing from the novel teachings and advantages of this invention. Accordingly, all such modifications are intended to be included within the spirit and scope of this invention as defined in the following claims.

What is claimed is:

1. A method for updating variable data to an encodation system employing previously encoded static data for a user specified item during an item transfer, comprising the steps of:
determining said previously encoded static data on said user specified item by electronically scanning an encoded static data into a data system prior to said item transfer;
said encoded static data being one of a serialized item specific designation and a non item specific designation with said data system;
determining a variable data need for said user specified item;
enumerating an item specific data content for said variable data need;
encoding said enumerated item specific data content and said encoded static data into a readable composite symbology encodation;
said composite symbology encodation having a first and a second encoded symbology portion, wherein said first encoded symbology portion includes said previously scanned encoded static data and said second encoded symbology portion is electronically joined to said first encoded symbology during said step of encoding enabling a combined reading of said portions to read said item specific data content following said item transfer;
updating said data system to recognize said readable composite symbology encodation for said user specified item; and
printing said second encoded composite symbology portion and applying said second encoded composite symbology portion on said user specified item proximate said first encoded symbology portion, whereby a downstream scan reads said composite symbology encodation of said user specified item and accesses said updated data system enabling a determination of said item specific data for said variable data need in combination with said encoded static data.

2. A system for updating variable data to an encodation system employing previously encoded static data for a user specified item during an item transfer, said system comprising:
a first module for determining said previously encoded static data on said user specified item by electronically scanning an encoded static data into a data system prior to said item transfer;
said encoded static data being one of a serialized item specific designation and a non item specific designation with said data system;
a second module for determining a variable data need for said user specified item;
a third module for enumerating an item specific data content for said variable data need;
a fourth module for encoding said enumerated item specific data content and said encoded static data into a readable composite symbology encodation;
said composite symbology encodation having a first and a second encoded symbology portion, wherein said first encoded symbology portion includes said previously scanned encoded static data and said second encoded symbology portion is electronically joined to said first encoded symbology during said step of encoding enabling a combined reading of said portions to read said item specific data content following said item transfer;
a fifth module updating said data system to recognize said readable composite symbology encodation for said user specified item; and
a sixth module for printing said second encoded composite symbology portion and applying said second encoded composite symbology portion on said user specified item proximate said first encoded symbology portion, whereby a downstream scan reads said composite symbology encodation of said user specified item and accesses said updated data system enabling a determination of said item specific data for said variable data need in combination with said encoded static data.

3. A method for updating variable data to an encodation system employing previously encoded static data for a user specified item during an item transfer, comprising the steps of:
determining said previously encoded static data on said user specified item by electronically scanning an encoded static data into a data system prior to said item transfer;
said encoded static data being one a serialized item specific designation within said data system;
determining a variable data need for said user specified item;
enumerating an item specific data content for said variable data need;
encoding said enumerated item specific data content and said encoded serialized item specific designation into an updated a machine readable item specific composite symbology encodation;
updating said data system to recognize said updated machine readable item specific composite symbology encodation for said user specified item;
printing said updated machine readable item specific encodation; and
applying said updated machine readable item specific encodation on said user specified item proximate said first encoded symbology portion over said previously encoded static data, whereby a downstream scan reads said updated composite symbology encodation of said user specified item and accesses said updated data system enabling a determination of said item specific data for said variable data need in combination with said encoded static data.
